(19) United States
(12) Patent Application Publication
(10) Pub. No.: US 2025/0299409 A1
(43) Pub. Date: Sep. 25, 2025

(54) Method for providing a digital animation of a predefined graphical element, control device, storage medium, motor vehicle, server apparatus, and system

(71) Applicant: AUDI AG, Ingolstadt (DE)

(72) Inventors: Matthias PFROMM, Ingolstadt (DE); Andreas Sebastian BINDER, Hepberg (DE); Moritz NEUBAUER, Krautheim (DE)

(73) Assignee: AUDI AG, Ingolstadt (DE)

(21) Appl. No.: 19/088,328

(22) Filed: Mar. 24, 2025

(30) Foreign Application Priority Data
Mar. 25, 2024 (DE) 10 2024 108 422.7

(51) Int. Cl. G06T 13/80; G06F 3/14; G06V 40/20; G10L 15/22

(52) U.S. Cl. CPC G06T 13/80; G06F 3/1423; G06V 40/20; G10L 15/22

(57) ABSTRACT

In an example, a digital animation of a graphical element may be provided by a control device that establishes a first display device having a display element, which display device may be used by a user at a first time, establishes the user's intention to use a structurally separate second display device and establishes the second display device. When establishing the intended use, the control device may ascertain status data and store the status data on a storage medium of a server apparatus. The status data describes the graphical element and/or its digital animation at the first time, which is before the first display device is changed by the user. The control device may provide an animation data set including the status data stored on the server apparatus, and transmit the animation data set at a second time to the second display device.

### CROSS-REFERENCE TO RELATED APPLICATIONS

This application claims the priority benefit of German Patent Application No. 10 2024 108 422.7 filed on Mar. 25, 2024, which is incorporated by reference herein in its entirety.

### BACKGROUND

### 1. Field

The examples of the invention relate to a method for providing a digital animation of a predefined graphical element, in particular an avatar. The digital animation is output to one or more display devices by way of the method. The examples of the invention also relate to a control device, a storage medium, a server apparatus, and a system comprising two display devices or at least two display devices, and a corresponding controller.

### 2. Description of the Related Art

Many manufacturers of computers or motor vehicles, for example, use personal assistants, such as virtual assistants, to support a user of a display appliance to use the personal assistants.

By way of progressive display technology and development of operator control concepts for motor vehicles, personal assistants in the motor vehicle support the driver, for example, in scheduling appointments. The driver enjoys the particular convenience of a virtual assistant when using the motor vehicle, and this convenience takes the load off the driver and facilitates the operator control of the motor vehicle. This makes the driver in the motor vehicle more efficient and more focused when carrying out their tasks.

DE 10 2008 028 512 A1 relates to a communication system having a display unit and a virtual being, which can be represented visually on the display unit and is designed for communication by means of natural language with a natural person.

DE 10 2009 018 591 A1 discloses a motor vehicle having an operator control apparatus for operator control of the motor vehicle, wherein the operator control apparatus comprises a display screen for presenting changing information and an operator control arrangement associated with the display screen. The motor vehicle here comprises a database with operator control instructions with regard to the operator control of the motor vehicle and the operator control apparatus can be used to select an operator control instruction from the database and to transfer same in converted or unconverted form to a mobile appliance with a display apparatus, said mobile appliance not being associated with the motor vehicle.

### SUMMARY

Example objects on which the invention is based is to improve an operator control concept across different appliances.

The example objects may be solved by way of a method, apparatuses and a system according to the invention in accordance with the recitation of the present claims. Other example advantageous developments may be provided by the dependent claims.

In an example, a database may be provided which describes a graphical element and/or its animation, stores same centrally and updates same during use. For example, provision may be made in each case of a current version of a personal assistant, which can be used by the user across different appliances and always in an up-to-date manner. This continuous use across multiple appliances is also enhanced by the fact that the user does not have to carry the previously used appliance with them in order to transfer the database. The use concept according to the described examples of the invention thus links different appliances, for example mobile terminals to a motor vehicle.

The method according to an example of the invention for providing a digital animation of a predefined graphical element may be carried out by a control device. A control device is understood to mean an appliance or an appliance component which is configured to receive and evaluate signals and to generate control signals and to transmit the control signals to other appliances or appliance components. To this end, the control device may comprise a reception module and/or a transmission module. The control device may, for example, be in the form of a control appliance or control chip.

A digital animation of a predefined graphical element, which may also be referred to as display content, is the presentation of changing information that is output visually. Such an animation may be an avatar. An avatar is a virtual being which, for example, can be presented visually on a screen and configured for communication with a natural person by use of natural language, and which may also be referred to as a digital representation of a being. For example, if the graphical element is a representation of a small robot, its animation can display a moving robot with its own facial expressions and body language.

The control device establishes a first display device having a display element, which display device is used by a user at a first time and the display element of which outputs the digital animation of the predefined graphical element. In this case, the first time is before one appliance is changed to another appliance. The user may be a predefined user, for example a user who has been authenticated and/or who has logged on to use the first display device, or who is assigned as a user of the first display device. For example, when the user starts a personal assistant on a screen of the motor vehicle, the control device can define and thus establish the screen of the motor vehicle as the first display device.

A display device is an appliance or an appliance component which is configured to output visible content. A display device may be in the form of a screen or monitor, wherein the component of the display device that outputs the display content is a display area.

The control device establishes by determining the user's intention to use a second display device, which is a display device of another appliance, that is to say an intended use of the other appliance. In other words, the control device establishes an intended change of appliance. The control device can establish, for example, a probable intended use of the user, an actual intended use, or, for example, the control device can establish whether a predefined intended use criterion which describes a predefined minimum probability that the user intends to change appliances is met. If the first display device is, for example, the display device of the motor vehicle and if the control device establishes that the user is leaving the motor vehicle and is carrying their smartphone with them, an intention to use the display device of the smartphone may thus be present. In another example, the control device may first establish that the user is leaving the motor vehicle and, at a later time, the control device may establish that the user turns on their smartphone. The user therefore does not necessarily have to carry the appliance with the second display device with them when the user uses the first display device.

The control device establishes the second display device, that is to say it may, for example, establish that the second display device is that of their smartphone because the user turns on the smartphone. The ascertained second display device is structurally separate from the first display device, that is to say is the display device of another appliance. In other words, the second display device is the one that the user is expected or likely to intend to use through the change of appliance. For this purpose, the control device can optionally first establish a use of the established second display device, for example by recognizing that the user turns on their smartphone and/or calls, for example, an assistance program, which uses the predefined graphical element as a personal assistant.

When establishing the intended use, the control device ascertains status data and stores the status data on a storage medium of a server apparatus. The ascertained status data describe the predefined graphical element and/or its digital animation, wherein the first time is a time during the use of the first display device, that is to say a time before the change of appliance. This means that the first time is a time at which the first display device outputs the animation of the predefined graphical element.

The status data may also be referred to as a database of the predefined graphical element and/or its animation.

In an example, the control device provides an animation data set comprising the status data stored on the server apparatus and transmits the provided animation data set at a second time to the second display device for displaying the animation data set. The animation data set describes the predefined graphical element in its embodiment described by the established status data, or in a supplemented or modified form.

The server apparatus, via which the information about the graphical element used is thus routed, is an appliance external to both display devices.

In contrast to the prior art, in which the database for a virtual being of an assistance program, for example, is permanently located in the vehicle or in a mobile appliance, the method according to the examples of the invention enables “distribution” of the animation always in its current form and with the current information status. This enables any number of appliances to always default to the updated version of the graphical element. This also means that a graphical element with current knowledge and/or current appearance is available for all appliances. The user does not have to “train” the personal assistant again for each appliance and, through external recognition, the graphical element, that is to say in particular a virtual being such as an avatar, becomes a companion in a life situation, gains personality as a personal assistant, that is to say gains a face, and accompanies the user for a long period of the day. Furthermore, the method according to the examples of the invention enables a reduction in the data rate in that not every appliance has its own, separate database for the personal assistant. Consequently, multiple appliances may also be synchronized or coordinated by the method according to the examples of the invention.

The method according to the examples of the invention can additionally make provision for the control device, for example when establishing the intended use or at the second time, to be able to generate a control signal, for a termination of the display of the graphical element to be able to be described by the first display device, and for the control device to then be able to transmit said control signal to the first display device. This completes the impression that the graphical element “jumps” from one appliance to the other appliance, even if the first display device is not used until the virtual assistant on another appliance has stopped being used. This also makes the personal relationship with the personal assistant much closer.

At least one or both of the display devices may be a display device of a mobile terminal, for example a smartwatch, a smartphone, a laptop, a pair of VR glasses, that is to say pair of smartglasses configured for displaying a virtual reality, or a pair of AR glasses, that is to say a pair of smartglasses configured for displaying an augmented reality. In an example, one of the two display devices may be a display device, for example, a screen of the center console of a motor vehicle, and another of the display devices may be a display device outside of the motor vehicle, for example a display device, for example a display device of a smartphone, a laptop, a household appliance or a smartwatch. The resulting link between the mobile terminal and the motor vehicle represents a significant improvement in the personal assistant's operator control concept and integrates the motor vehicle into part of the users' daily routine by not using the motor vehicle. The control device can thus, for example, also store information obtained by driving, such as a destination, as knowledge, and can use this information outside of the motor vehicle as a basis for supporting the user. This makes a virtual personal assistant much more efficient.

In one development, to establish the intended use, the control device can establish entry to the motor vehicle and/or exiting from the motor vehicle, and/or an intention of the user to enter and/or exit the motor vehicle. These are indicators of an intended change of appliance that reliably describe same. Entering or leaving the vehicle is also symbolized and visualized for the user by the “jumping” of the digital animation. The bond with the personal assistant becomes even better and the support of the user becomes much more efficient.

In an example, which can optionally be combined with the example in which a display device is an appliance of a motor vehicle, the control device can establish the intended use with reference to the motor vehicle sensor system. The control device can establish the intended use based on an ignition signal received from an ignition system of the motor vehicle; and/or a seatbelt signal received from a sensor system for checking a seatbelt, said seatbelt signal being able to describe, for example, closing or opening of the seatbelt on the driver's seat; and/or a door signal received from a closing device of the motor vehicle, said door signal being able to describe the opening, closing, unlocking and/or locking of a door of the motor vehicle; and/or a pressure signal received from a seat sensor system of the motor vehicle, based on which the control device can derive, for example, the user standing up or sitting down; and/or a surveillance signal from a surveillance camera of the motor vehicle, for example an exterior and/or interior camera of the motor vehicle. These are particularly useful indicators for deriving an intention of the user wishing to use or to no longer use the display device of the motor vehicle.

As an alternative or in addition, the control device may establish the intended use by gesture recognition of a predetermined user gesture; and/or based on an approach and/or removal of one appliance towards the other appliance or from the other appliance; and/or by voice recognition of a user's voice command; and/or based on the user logging into and/or logging out of a user account in a predefined digital space. This enables particularly intuitive operator control and activation of the digital animations.

The ascertained status data can describe graphical data and/or animation data of the predefined graphical element, that is to say data describing an appearance and/or an example of the predefined graphical element, and/or, for example, a movement behavior of the animated graphical element. If the predefined graphical element is an avatar, the status data ascertained at the first time can describe, for example, the fact that the avatar can have the look and appearance of a small robot with a predefined shape, predefined color and a predefined facial expression.

The graphical data can additionally describe a character of such a virtual being, for example a funny appearance, humorous communication and/or, for example, fluid and light or nimble movements. Thus, the graphical element appears after the change of appliance on the display element of the second display device in the same manner as before on the first display device.

In one development, the control device can establish a size and/or an example of the display element of the second display device and adapt the graphical data to the established size and/or the established display element. An avatar depicted on a center screen of a motor vehicle can then be represented, for example, as a small robot with a multifaceted facial expression, but at a later time on a screen of a smartwatch as a small stylised robot, for example. This optimizes the display on an appliance-specific basis and makes better use of the display area.

In another example, the ascertained status data can describe an information data set which is coupled to the predefined graphical element at the first time. For example, if the user has conversed with the avatar in the motor vehicle and the control device has collected information in this conversation, for example about where the user is going with the motor vehicle or why the user is interrupting the journey, or has a program that describes the virtual assistant, for example has downloaded information from the Internet and stored it, this information is still present when using the second appliance, which significantly improves the efficiency of a holistic user concept across multiple appliances. Such information, which represents the level of knowledge of the personal assistant, may, for example, originate from the Internet or, for example, from other appliances, for example a navigation appliance, or may be analyzed and stored on the basis of communication with the user. The information data set can describe information about communication with the specified user and/or information about one or more journeys of the specified user using a motor vehicle.

For application cases or application situations which may arise in the method and are not explicitly described here, provision may be made according to the method for an error message and/or a request for input of user feedback to be issued and/or a default setting and/or a predetermined initial state to be set.

The control device for the motor vehicle is also included in the examples of the invention. The control device of the motor vehicle may comprise a data processing apparatus or a processor device configured to carry out an example of the method according to the invention. For this purpose, the processor device can have at least one microprocessor and/or at least one microcontroller and/or at least one FPGA (field-programmable gate array) and/or at least one DSP (digital signal processor). In particular, a CPU (central processing unit), a GPU (graphical processing unit) or an NPU (neural processing unit) can be used as microprocessor. Furthermore, the processor device can have program code, which is configured when executed by the processor device, to carry out the examples of the method according to the invention. The program code can be stored in a data memory of the processor device. The processor device may be based, for example, on at least one circuit board and/or on at least one SoC (system on chip).

As a further solution, the examples of the invention also comprise a computer-readable storage medium comprising instructions which, when executed by a computer or a computer network, causes it to carry out the method according to the examples of the invention. The storage medium may be provided at least partially as a non-volatile data memory (for example as a flash memory and/or as an SSD-solid state drive) and/or at least partially as a volatile data memory (for example as a RAM-random access memory). The storage medium may be arranged in the computer or computer network. However, the storage medium may also be operated, for example, as what is known as an app store server and/or cloud server on the Internet. The computer or computer network can be used to provide a processor circuit with, for example, at least one microprocessor. The program code may be provided as binary code and/or as assembler code and/or as source code of a programming language (for example C) and/or as a program script (for example Python). The storage medium may be configured, for example, as a memory card or memory chip or other data memory. This results in the advantages already mentioned.

The example objects may be achieved by a motor vehicle having an the control device according to the described examples of the invention. This results in the advantages discussed above. The motor vehicle according to the described examples of the invention may be in the form of a motor car, in particular a passenger car or truck, or in the form of a minibus or motorcycle.

The example objects may be achieved by a server apparatus for operating on the Internet, for example a data server, a backend and/or a data cloud, wherein the server apparatus has the storage medium according to the examples of the invention.

The example objects may be achieved by a system according to the examples of the invention comprising two display devices or at least two display devices, as well as an the control device according to the examples of the invention and/or an the server apparatus according to the examples of the invention. This too results in the example advantages described above. The two display devices are display devices of different appliances in this case. In particular, the system according to the examples of the invention can comprise the two appliances with the respective display device, as well as the server apparatus.

The examples of the invention also include developments of the control device, the storage medium, the motor vehicle, the server apparatus and the system, which have features as have already been described in connection with the developments of the method according to the examples of the invention. For this reason, the corresponding developments of the control device, the storage medium, the motor vehicle, the server apparatus and the system, may not described here again.

The examples of the invention also comprises the combinations of the features of the described examples. The examples of the invention thus also comprises implementations which have a respective combination of the features of several of the described examples, unless the examples have been described as being mutually exclusive.

### BRIEF DESCRIPTION OF DRAWINGS

Examples of the invention are described below. In the figures:

FIG. 1 shows a schematic illustration of a system, and apparatuses according to an example the invention and a method according to an example of the invention;

FIG. 2 shows another schematic illustration of a system, and a server apparatus according to the an example of the invention and a method according to an example of the invention; and

FIG. 3 shows another schematic illustration of a system, and a server apparatus according to an example of the invention and a method according to an example of the invention.

### DESCRIPTION

The examples explained below are examples of the invention. In the examples, the described components each represent individual features that should be considered independently of one another and that each may also be developed independently of one another. The disclosure is therefore also intended to comprise combinations of the features of the examples other than those illustrated. Furthermore, the described examples are also able to be supplemented by more of the features of the examples that have already been described.

In the figures, identical reference designations each denote functionally identical elements.

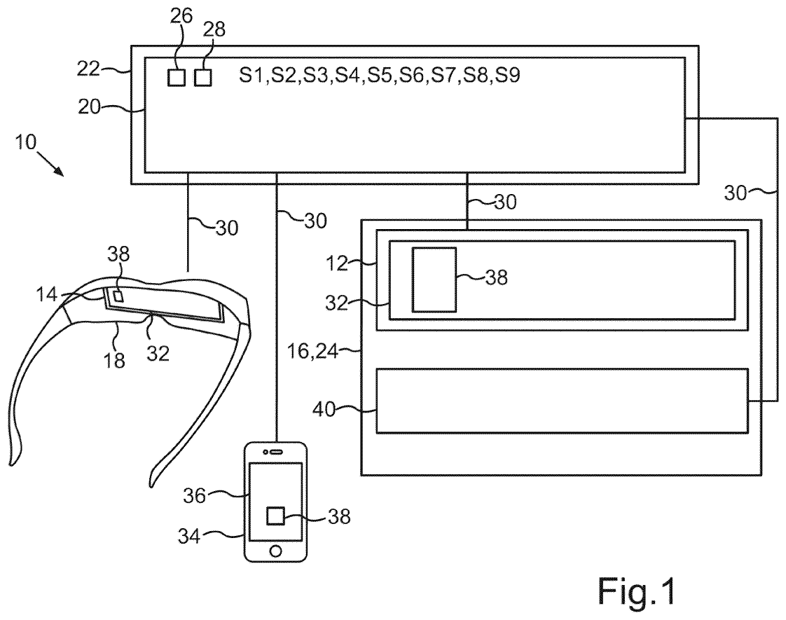

FIG. 1 shows a schematic illustration of a system 10 with multiple display devices 12, 14, 36. The respective display devices 12, 14, 36 are in this case structurally separate from one another and belong to different appliances 16, 18, 34. Therefore, the system 10 may also have at least two or more appliances 16, 18, 34. In addition to the display devices 12, 14, 36 or appliances 16, 18, 34, the system 10 also comprises an example of the control device 20, or a server apparatus 22 comprising the control device 20.

In the example of FIG. 1, the appliance 16 may be a motor vehicle 24. In the example of FIG. 1, although the control device 20 is shown as a component of the server apparatus 22, the control device 20 may optionally also be a component of one of the appliances 16, 18, for example a control appliance of the motor vehicle 24.

The control device 20 may comprise a processor device 26 and/or a storage medium 28. The processor device 26 may comprise, for example, one or more microchips or microprocessors. The storage medium 28 may be configured, for example, as a memory chip, a hard drive or other common storage medium. The example of the control device 20 shown in FIG. 1 as a component of the server apparatus 22 may be provided so that the storage medium 28 of the control device 20 is also the storage medium on which the status data of the predefined graphical element and its digital animation can be stored. The server apparatus 22 may be in the form of a common data server, for example a hardware server or a data cloud. Data may be communicated with the display devices 12, 14 via wireless data communication connections 30, for example via an Internet connection, WLAN connection, mobile communication connection or Bluetooth connection.

In the example of FIG. 1, the exemplary motor vehicle 24 may have a display as display device 12, for example a screen of the center console or on a dashboard of the motor vehicle 24. Such a display device 12 may comprise a display area as display element 32. Likewise, the display device 14 may comprise a display area as display element 32, wherein the appliance 18 may, for example, be in the form of smartglasses or VR glasses. Other examples of the appliance 18 may be, for example, a computer, a laptop, a smartwatch or a computer or a pair of smartglasses, on which a user can log in to a virtual world (“metaverse”).

In the example of FIG. 1, a user can, for example, use the motor vehicle 24 with the display device 12 of the motor vehicle 24, and multiple different mobile terminals, for example, the appliances 18 and 34. The user can use the appliance 34, for example a smartphone, having a display device 36, to display the digital animation of the predefined graphical element 38, for example before driving using the motor vehicle 24. The predefined graphical element 38 can represent a virtual being here, in particular an avatar. In this case, the first display device may then be the display device 36 of the appliance 34, and the second display device that of the motor vehicle 24. When the user of the motor vehicle 24 then uses the appliance 18 after the journey or in a break from driving, that is to say the exemplary smartglasses during a break in which the user visits, for example, a motorway service station, then the relative reference of the display devices 12, 14 to one another change for the transition of the predefined graphical element 38 so that the display device 12 is the first display device, and the display device 14 can be defined as the second display device. In other words, the “first display device” is the one that outputs the predefined graphical element 38 before a change of appliance, and the “second display device” is the one that then adopts the predefined graphical element, that is to say to which the graphical element 38 “jumps”.

The predefined graphical element 38 may be, for example, an animated representation of a small robot or another figure, for example depending on a user-specific setting. The digital animation of the predefined graphical element 38 can represent this movably and/or three-dimensionally, and in a manner controlled by a program code that supports speech recognition, and a speech output controlled, for example, by artificial intelligence, thus enabling communication with the user.

In the example of FIG. 1, a user of the motor vehicle 24 may have planned, for example, a vacation trip to the south of France. The predefined graphical element 38 may be a virtual being, in particular an avatar, which may have, for example, the appearance of a small robot and which can be movably reproduced by digital animation on a display and can be linked to speech recognition and speech output. For example, using artificial intelligence, that is to say an artificial neural network, provision may be made for the avatar's database to enable the user to converse with the avatar and for information about the conversation with the user to be stored in the database. For example, even before using the motor vehicle 24, the user may have used the avatar configured as a personal assistant to inform the user about the traffic conditions and the weather during the journey and to store information on the planned travel route accordingly. These may be established and stored as a result of speech recognition, and/or downloaded from the Internet, for example, or retrieved from another appliance, such as a navigation appliance.

The exemplary avatar can initially be connected by the control device 20 to artificial intelligence and/or artificial intelligence can be provided anew for the exemplary avatar (for example comparable to a chatbot, which uses artificial intelligence to communicate with users via text-based messages and/or images). This artificial intelligence is constantly learning and is therefore a kind of “memory of the avatar”. The artificial neural network may, for example, be linked to the control device 20 or may be integrated in the control device 20.

Artificial intelligence or an artificial neural network can be understood as software code that is stored on a computer-readable storage medium and represents one or more networked artificial neurons or can replicate their function. The software code may also contain multiple software code components which may, for example, have different functions. In particular, an artificial neural network may implement a non-linear model or a non-linear algorithm that maps an input to an output, wherein the input is given by an input feature vector or an input sequence and the output, for example an output category for a classification task, may include one or more predicted values or a predicted sequence.

The control device 20 can accordingly establish in S1 that, at the time of use of the appliance 34, the exemplary smartphone, the display device 36 of which is used for output of the avatar and accordingly can establish the display device 36 at this time as the first display device.

To establish S2 the user's intention to no longer use the display of the appliance 34 but rather the display device 12 of the motor vehicle 24 at a change time, the control device 20 can, for example, receive and evaluate geographical data of the motor vehicle 24 and the appliance 34, and in this case establish an approach of the appliance 34 toward the motor vehicle 24 if the user goes toward the motor vehicle 24 and the control device establishes, for example, that the user is approaching the motor vehicle 24. For example, the control device 20 can predict the anticipated change of appliance when a predefined value of a minimum distance between the user or mobile terminal and the motor vehicle 24 is undershot.

As an alternative, in order to establish (S2) the intention to change the display appliance, the control device 20 can establish a user entering the motor vehicle 24, for example via a signal received by the control device 20 from a radio key of the motor vehicle 24, a received voice command from the user, or based on a signal from a motor vehicle sensor system 40, which, for example, establishes an opening of a door and can transmit a corresponding signal to the control device 20.

As an alternative or in addition, the control device 20 can receive from the motor vehicle sensor system 40 a signal (or multiple signals) which is, for example, an ignition signal and can describe starting of an ignition of the motor vehicle 24, a seat belt signal which can describe, for example, a closing of a seat belt on the driver's seat, a signal from a locking system of the motor vehicle 24 which can describe the opening of the motor vehicle door, and/or a pressure signal from a seat sensor system of the motor vehicle 24 which can describe, for example, a pressurization of the driver's seat. In the latter case, the control device 20 can then derive, for example, the fact that a driver has sat in the motor vehicle 24 and therefore now wants to use the exemplary screen of the center console. In addition or as an alternative, the control device 20 can receive and evaluate a monitoring signal of the motor vehicle 24 which, for example, comes from a surveillance camera and can describe, for example, an image or images of the interior of the motor vehicle and/or the external environment of the motor vehicle. For example, the control device 20 can use image recognition to establish that the user is approaching the motor vehicle 24 or that persons are in the motor vehicle 24; the intended use can be established based on this (S2).

In the case of a corresponding change from the motor vehicle 24 as the appliance 16, the display device 12 of which is used by the user during the journey, to a display device 14, the control device 20 can accordingly establish at a later time an exit or an intended exit of the user from the motor vehicle 24, switching off of the ignition, a release of the seat belt, an opening—or locking—of the door, an end of a pressure load in the driver's seat and/or a corresponding image or video recording.

In addition or as an alternative, other triggers are possible for establishing the intent to use another display device, for example establishing S2 the intent to use the change of appliance by gesture recognition, by a voice command by the user, and/or by establishing that the user logs into and/or logs out of a user account of a digital space. The latter is particularly advantageous if the exemplary personal assistant, that is to say the digital animation of the predefined graphical element 38, is used, for example, in the metaverse.

The target appliance can alternatively be selected via a presetting or via communication, that is to say via operating gesture or a voice command, for example.

In the example of FIG. 1, the control device 20 at the time of the change of the appliances can establish, for example, the screen of the center console of the motor vehicle 24 as the second display device 12 (S3). The time for establishing the status data of the predefined graphical element 38 (S4) may be the time for changing the appliances (“change time”) or for example a time before the change of appliance. In an example, the control device 20 can ascertain the status data at regular intervals (S4) and store (S5) same on the storage medium 28 of the server apparatus 22 even before the change of appliance. In the example of FIG. 1, the status data or the database for the digital animation of the graphical element 38 can describe, for example, the design of the predefined graphical element 38 as a small robot, and optionally give a detailed description of the graphical element 38, for example resolution, size and detail richness of the graphical element 38. In an example, however, provision may be made for the control device 20 to adapt specific details, for example the resolution and the number of details of the graphical element 38, depending on the display device to be used 12, 14, 36. Thus, for example, in the example of FIG. 1, a lower resolution of the graphical element 38 may be provided on the display device 36 of the appliance 34 due to the limited screen area, and the resolution may vary depending on the ascertained second display device 12.

The status data ascertained (S4) by the control device 20 in S4 during the use of the device 34 comprise an information data set, for example the information about the travel route ascertained during the use of the smartphone, the information from the query of the weather and the queried traffic news. This information can describe the avatar's “knowledge level”.

In S6, the control device 20 establishes, for example, that the user of the motor vehicle 24 is starting and thus the screen of the center console, that is, the exemplary display device 12, is turned on. At the second time, that is to say at the time of use of the second display device 12, the control device 20 in S7 provides an animation data set comprising the status data stored on the storage medium 28. In this case, the animation data set may comprise only the database, that is to say only the stored status data or, in addition to the status data, a signal for outputting the graphical element 38 by the display element 32.

In the example of FIG. 1, the control device 20, as previously mentioned, can adapt (S8) the status data for the output of the graphical element 38. In this case, the control device 20 can establish, for example, that the graphical element 38 output by the screen of the center console can have a higher resolution due to the size of the screen of the center console and, for example, can show multiple details of the example robot, and this can be established in the animation data set. In S9, the server apparatus 22 transmits the provided animation data set via the data communication connection 30 to the screen of the center console of the motor vehicle 24. During the journey, the avatar is then output through the center console screen and animated on the center console screen.

Optionally, provision may be made for a program, which can describe the animation of the graphical element 38, in the motor vehicle 24 to also be able to include a driver training program. In this case, the control device 20 can record and evaluate travel data, for example. For example, if the driver drives particularly well on their journey to the south of France, for example in a particularly fuel-efficient manner, particularly cautiously and/or if the driver consistently adheres to the speed limits, the driver can collect “points”, for example. If the driver reaches a predefined score, the control device 20 can adapt (S8) the graphical data of the graphical element 38, for example, in such a way that the avatar is displayed with the addition of a racing cap on its head after reaching the predefined score. The next time the control device 20 in S4 establishes the status data, the representation of the racing cap can then be stored via the database.

At another time on the road trip to the south of France, for example, the driver may decide to take a break at a service station. For example, via the seat sensor system or via the fact that the user having a further appliance 18, for example a pair of smartglasses, is established at a distance from the motor vehicle 24, the control device 20 can now establish (S1) the screen of the center console of the motor vehicle 24 as the first display device, and the exemplary smartglasses as the second display device 14 (S3), that is to say as the display device 14 that “takes over” the avatar from the screen of the center console. While the screen of the center console no longer displays the graphical element 38, the control device 20 can adapt the database stored in the storage medium 28 (S8) in such a way that the avatar is only displayed in a stylized manner on the smartglasses. This adapted database, that is to say this provided animation data set, can then be transferred again in S9 from the storage medium 28 to the appliance 18.

During the break at the service station, the driver may, for example, buy a milkshake and, optionally, the control device 20 can receive and evaluate this, for example, by linking with a digital program, which may, for example, additionally record a money transfer from, for example, a credit card of the user. As an alternative, the control device 20 may, for example, analyze the order of the milkshake via voice recognition via a microphone of the appliance 18 and adapt the database for the avatar (S8) in such a way that the avatar is displayed from this time with a milkshake in its hand. When the user with the smartglasses approaches the motor vehicle 24, the database of the avatar can then be transmitted again via the path via the server apparatus 22 to the display device 12 of the motor vehicle 24.

For example, if one of the appliances 18, 34 is a smartwatch, the control device can, for example, make an adaptation S8 in such a way that the avatar is very highly stylized. If the control device 20 establishes a user logging in to the metaverse, the avatar can preferably be adapted (S8) in such a way that the avatar has a very high resolution and, for example, shows additional details such as further body parts. If the control device 20 establishes, for example, by means of an image analysis of a recording of the interior camera that children are located in the motor vehicle 24, the control device 20 can adapt the animation data set, for example, in such a way that the avatar has a very childlike appearance, for example, very large eyes and colorful clothing.

In an example, provision may be made for the appliances 18, 34 and the motor vehicle 24 to be user-specific appliances 18, 34. For this purpose, the appliances 18, 34 and the motor vehicle 24 may be registered, for example, on the user.

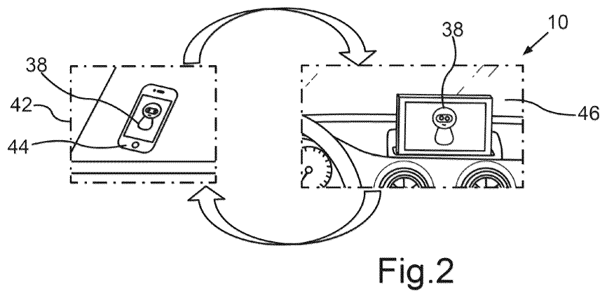

FIG. 2 schematizes another example and shows the system 10, a section 42 in which a mobile terminal 44, for example a smartphone, is located on a desk, and a section 46 of a cockpit of the motor vehicle 24 with the display device 12, for example the screen of the center console. Both appliances are shown with their display devices on which the predefined graphical element, for example, in the form of a small robot, is displayed. In an example, however, provision may be made for the output of the graphical element 38 on the respective first display device to end as soon as the appliance is changed. The change of appliance and the “jump” of the graphical element 38 is indicated in FIG. 2 by the arrows. For reasons of better clarity, the control device 20 is not shown in FIG. 2, and neither is the server apparatus 22. Components that are not shown in FIG. 2, however, may be part of the system 10 and the method as described in FIG. 1.

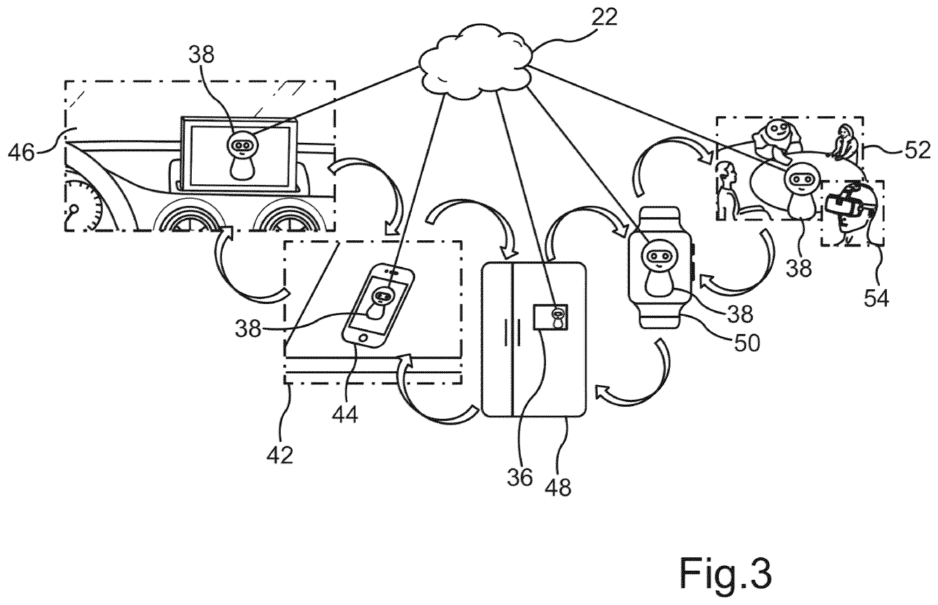

FIG. 3 illustrates another example and focuses on the switchover of the display of the graphical element 38 to different appliances, for example to the mobile terminal 44, the display device 12 of the motor vehicle 24, to a display device 36 of a refrigerator 48, to a display device of a smartwatch 50, and in a metaverse 52, for example via a pair of smartglasses 54. The server apparatus 22 is shown in a stylized manner and may comprise the control device 20. Components that are not shown in FIG. 3, however, may be part of the system 10 and the method as described in FIG. 1.

Overall, the examples show how a “jump” of an avatar, for example, can be provided as a graphical element 38 from, for example, a smartphone to a motor vehicle 24.

In another example, for example, when leaving the motor vehicle 24, communication takes place between the motor vehicle 24 and the smartphone or the smartwatch of the driver. The exemplary avatar moves toward the appliance 18, which the driver has with them when leaving the motor vehicle 24. The digital representation of the exemplary avatar is located on the server apparatus 22, for example on a central server, for example a cloud, and is transferred to the respective appliance 18, 50, 44, 48, 34, 54, 52, in this case the exemplary smartphone. The driver gets the impression that the exemplary avatar is wandering from appliance to appliance. When entering, the same happens: communication takes place between the motor vehicle 24 and, for example, the telephone, the digital instance is loaded from the exemplary cloud into the motor vehicle 24 and the avatar visibly wanders into the motor vehicle 24. Similarly, jumping to other appliances 18, 34, 44, 48, 50, 54, 52, like “smart” household appliances or virtual worlds, like the “metaverse”, is possible.

The digital representation of the exemplary avatar is stored in the server apparatus 22, for example the aforementioned cloud (S5), so that the exemplary avatar can jump, for example, from smart device to smart device, in order to accompany the user continuously.

According to another example of technical implementation, provision may be made for:
1. Leaving the motor vehicle 24 to be established.
2. The motor vehicle 24 to connect to the smart device.
3. The digital representation of the exemplary avatar to be loaded from the sample cloud onto the smart device.
4. The exemplary avatar to disappear from the motor vehicle 24 and to appear on the smart device.
5. The same to happen when entering the motor vehicle 24, but vice versa.
6. The same to be able to happen between other appliances.

In another example, the digital representation of the exemplary avatar as a graphical element 38 may be located on a central server or a cloud. An instance of the exemplary avatar accompanies the user and can jump between terminals. For example, when entering the motor vehicle 24, the exemplary avatar jumps from the mobile phone to the vehicle display and, when leaving the motor vehicle 24, the avatar jumps from the motor vehicle 24 to the telephone. Entry and exit can be established, for example, by direct communication between the appliances. The avatar may also jump, for example, to a smartwatch, “smart” household appliances and/or also to virtual worlds of the “metaverse”.

A description has been provided with particular reference to examples, but it will be understood that variations and modifications can be effected within the spirit and scope of the claims, which may include the phrase “at least one of A, B and C” as an alternative expression that refers to one or more of A, B or C, contrary to the holding in Superguide v. DIRECTV, 358 F3d 870, 69 USPQ2d 1865 (Fed. Cir. 2004).

1. A Method of providing a digital animation of a graphical element among at least two display devices, comprising:
executing by a control device including a processor device a process including,
establishing a first display device, of the at least two display devices, having a display element, which display device is used by a user at a first time and the display element of which outputs the digital animation of the graphical element,
determining an intended use of the user to use a second display device, of the at least two display devices, and establishing the second display device, which is structurally separate from the first display device and which the user intends to use by changing an appliance including the first display device,
when establishing the intended use, ascertaining status data and storing the status data on a storage medium of a server apparatus, wherein the status data describe the graphical element and/or the digital animation of the graphical element at the first time, which is before the appliance is changed by the user,
providing an animation data set comprising the status data stored on the server apparatus, and
transmitting the animation data set at a second time to the second display device;
wherein the server apparatus is an appliance external to both the first display device and the second display device.

2. The method according to claim 1, wherein one of the at least two display devices is a display device of a motor vehicle, and another of the at least two display devices is a display device outside of the motor vehicle.

3. The method according to claim 2, wherein, to determine the intended use, the control device determines entry to the motor vehicle and/or exiting from the motor vehicle; and/or an intention of the user to enter and/or exit the motor vehicle.

4. The method according to claim 2, wherein the control device determines the intended use based on at least one signal, from among signals, including:
an ignition signal received from an ignition system of the motor vehicle; and/or
a seatbelt signal received from a sensor system for checking a seatbelt; and/or
a door signal received from a closing device of the motor vehicle which describes an opening, closing, unlocking and/or locking of a door of the motor vehicle; and/or
a pressure signal received from a seat sensor system of the motor vehicle; and/or
a surveillance signal from a surveillance camera of the motor vehicle, the surveillance camera being an exterior and/or interior camera of the motor vehicle.

5. The method according to claim 2, wherein the control device determines the intended use by at least one criterion, from among criteria, including:
gesture recognition of a user gesture; and/or
an approach and/or removal of a first appliance with the first display device towards and/or from a second appliance with the second display device; and/or
voice recognition of a voice command of the user; and/or
the user logging into an account of the user and/or logging out of an account of the user for a defined digital space.

6. The method according to claim 1, wherein the status data describe graphical data of the graphical element which describe an appearance and/or a representation of the graphical element.

7. The method according to claim 6, wherein the control device determines a size and/or a display element of the second display device and configures the graphical data to the size and/or the display element of the second display device.

8. The method according to claim 2, wherein the status data describe an information data set coupled to the graphical element at the first time; wherein the information data set describes information about a communication with the user and/or information about one or more journeys of the user using the motor vehicle.

9. The method according to claim 1, wherein at least one of the at least two display devices is a display device of a mobile terminal, a smartwatch, a smartphone, a laptop, a pair of VR glasses or a pair of AR glasses.

10. The method according to claim 1, wherein the digital animation of the graphical element describes a virtual being in form of an avatar.

11. A control device including a processor device configured to execute a process comprising:
establishing a first display device, of at least two display devices, having a display element, which display device is used by a user at a first time and the display element of which outputs a digital animation of a graphical element,
determining an intended use of the user to use a second display device, of the at least two display devices, and establishing the second display device, which is structurally separate from the first display device and which the user intends to use by changing an appliance including the first display device,
when establishing the intended use, ascertaining status data and storing the status data on a storage medium of a server apparatus, wherein the status data describe the graphical element and/or the digital animation of the graphical element at the first time, which is before the first display device is changed by the user,
providing an animation data set comprising the status data stored on the server apparatus, and
transmitting the animation data set at a second time to the second display device;
wherein the server apparatus is an appliance external to both the first display device and the second display device.

12. A non-transitory computer readable storage medium storing a program code which is configured to execute the process according to claim 1 when the program is executed by the control device.

13. A server apparatus operating on Internet, comprising the non-transitory computer readable storage medium according to claim 12.

14. A motor vehicle comprising the control device according to claim 11.

15. A system comprising the at least two display devices and the control device according to claim 11.

16. A system comprising the at least two display devices and the server apparatus according to claim 13.
